(19) United States
(12) Patent Application Publication
(10) Pub. No.: US 2026/0037102 A1
(43) Pub. Date: Feb. 5, 2026

(54) ELECTRONIC DEVICE AND METHOD OF TESTING ELECTRONIC DEVICE

(71) Applicant: Getac Technology Corporation, New Taipei City (TW)

(72) Inventor: Xiao-Jyun CHEN, Taipei City (TW)

(21) Appl. No.: 19/176,235

(22) Filed: Apr. 11, 2025

Related U.S. Application Data
(60) Provisional application No. 63/678,734, filed on Aug. 2, 2024.

(51) Int. Cl. G06F 3/0482; G06F 3/0487; G06F 3/16

(52) U.S. Cl. CPC G06F 3/0482; G06F 3/0487; G06F 3/167

(57) ABSTRACT

A method of testing an electronic device includes displaying a first screen by an user interface of a display device, in which the first screen includes a first task content and a first interactive button. The first interactive button has a countdown reading area and a text area. When a number displayed in the countdown reading area is counted down to zero, the user interface is switched to a second screen different from the first screen. When the display device detects a first action result of the first interactive button and the first action result is that the first interactive button is activated, the user interface is switched to the second screen, and execution data corresponding to the first task content is stored by a memory.

### CROSS-REFERENCE TO RELATED APPLICATION

This application claims priority to U.S. Provisional Application Ser. No. 63/678,734, filed on Aug. 2, 2024, which is herein incorporated by reference in its entirety.

### BACKGROUND

### Field of Invention

The present disclosure relates to a device and a method, and in particular to an electronic device and a method of testing the electronic device.

### Description of Related Art

Market diagnostics for hardware and system performance utilize two primary methods. The first method is a continuous diagnostic task. This method is an interface having a task countdown mechanism; if a task's testing time is exceeded, the system automatically jumps to the next task. A drawback is that the user must wait for the countdown to complete before skipping the task. The second method is the operational diagnostic task. The user must complete a task operation to proceed to a next testing item. The interface usually has a skip button, but the disadvantage is that it cannot continuously go through the task. This makes it more difficult for the user to deal with a task stuck situation. Current designs of the countdown interaction tend to interfere with the diagnostic images and illustration, which affects the operating experience.

### SUMMARY

The present disclosure describes a method of testing the electronic device. The method includes: a first screen is displayed by a user interface of a display device, in which the first screen includes a first task content and a first interactive button, and the first interactive button has a countdown reading area and a text area; when a number displayed in the countdown reading area is counted down to zero, the user interface is switched to a second screen different from the first screen; and when the display device detects a first action result of the first interactive button and the first action result is that the first interactive button is activated, the user interface is switched to the second screen, and execution data corresponding to the first task content is stored by a memory.

The present disclosure describes an electronic device including a display device, a processor, and a memory. The display device provides a user interface. The user interface displays a first screen, in which the first screen includes a first task content and an interactive button. The interactive button includes a countdown reading area and a text area. The processor counts down the number associated with the first task content and outputs a control signal to the display device to display the number in the countdown reading area. When the number is counted down to zero, the user interface is switched to a second screen different from the first screen. When the display device detects an action result of the interactive button and the action result is that the first interactive button is activated, the processor further outputs the control signal to the display device based on the action result for switching the user interface to the second screen. The memory stores execution data corresponding to the first task content.

### BRIEF DESCRIPTION OF THE DRAWINGS

The invention can be more fully understood by reading the following detailed description of the embodiment, with reference made to the accompanying drawings as follows:

FIG. 1 illustrates a block diagram of an electronic device, in accordance with one embodiment of the present disclosure.

FIG. 2 illustrates a flow chart of a method of testing the electronic device, in accordance with one embodiment of the present disclosure.

FIG. 3 illustrates a diagram of a task select screen provided by a display device, in accordance with one embodiment of the present disclosure.

FIG. 4 illustrates a diagram of a first screen provided by the display device, in accordance with the embodiment of the present disclosure.

FIG. 5 illustrates a diagram of a second screen provided by the display device, in accordance with the embodiment of the present disclosure.

FIG. 6A illustrates a diagram of a third screen provided by the display device, in accordance with the embodiment of the present disclosure.

FIG. 6B illustrates a diagram of a third screen provided by the display device, in accordance with the embodiment of the present disclosure.

FIG. 7 illustrates a diagram of a test result screen provided by the display device, in accordance with the embodiment of the present disclosure.

FIG. 8 illustrates a block diagram of the electronic device, in accordance with the embodiment of the present disclosure.

FIG. 9A illustrates a diagram of an embodiment provided by the display device, in accordance with the embodiment of the present disclosure.

FIG. 9B illustrates a diagram of an embodiment provided by the display device, in accordance with the embodiment of the present disclosure.

### DETAILED DESCRIPTION

The following drawings and detailed will illustrate the spirit of this present disclosure, and any person having ordinary skill in the art may make changes and modifications to the technology taught herein without departing from the spirit and scope of this present disclosure after understanding the better embodiment of this present disclosure.

It should be understood that in the description herein and in the scope of all claims, when an element is said to be “connected” or “coupled” to another element, it can be directly connected or coupled to the other element, or there can be an insertion element. In contrast, when an element is said to be “directly connected” or “directly coupled” to another element, there is no insertion element. In addition, “electrically connected” or “connected” may also refer to the inter-operation or interaction between two or more elements.

It should be understood that in the description herein and in the scope of all claims, the terms “comprises,” “includes,” “has,” “contains,” and the like, as used herein, are open-ended terms that mean “includes but is not limited to.”

It should be understand that in the description herein and in the scope of all claims, unless otherwise defined, all terms used, including technical and scientific terms, have the same meaning as understood by a person skilled in the art in the field hereof. It is further understood that unless expressly stated herein, such terms, such as those defined in commonly used dictionaries, should be construed as having a meaning consistent with their meaning in the context of the relevant field, and should not be interpreted in an idealized or overly formal manner.

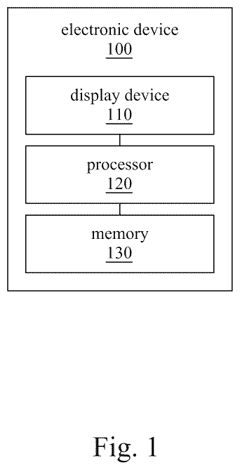

Please refer to FIG. 1. FIG. 1 illustrates a block diagram of an electronic device 100, in accordance with one embodiment of the present disclosure. The electronic device 100 includes a display device 110, a processor 120, and a memory 130. In connection relation, the display device 110 is coupled to the processor 120, and memory 130 is coupled to the processor 120.

The electronic device 100 can be a personal computer, a laptop, and a mobile device (such as a cell phone or a tablet), or a similar electronic device.

The display device 110 can be a monitor, a touch display panel, or a similar display device in the electronic device 100.

The processor 120 can be one or more central processing units (CPUs), one or more graphic processing units (GPUs), one or more digital signal processors (DSPs), one or more micro processing units (MPUs), one or more micro control units (MCUs), or one or more similar devices.

The memory 130 can be one or more static random access memory (SRAM) devices, one or more dynamic random access memory (DRAM) devices, one or more flash memory devices, one or more random access memory (RAM) devices, one or more erasable programmable read only memory (EPROM) devices, one or more electrically erasable programmable read only memory (EEPROM) devices, or one or more similar devices.

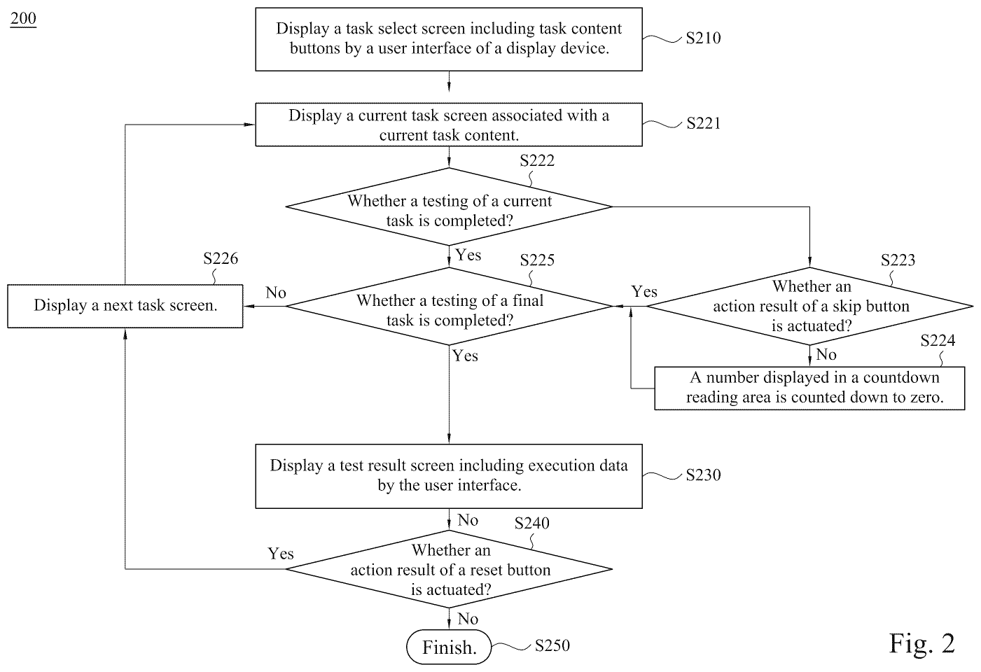

In some embodiments, in a process of testing the electronic device 100, the processor 120 is configured to perform at least one of test tasks, in which task contents and execution data associated with task contents can be stored in the memory 130. In some embodiments, the processor 120 performs computer-readable codes stored in the memory 130 to test the electronic device 100. The display device 110 provides a user interface, which is configured for selection of tasks. The processor 120 performs a series of operation based on a command corresponding to task selecting received by the display device 110. This is illustrated in detailed in FIG. 2 to FIG. 7.

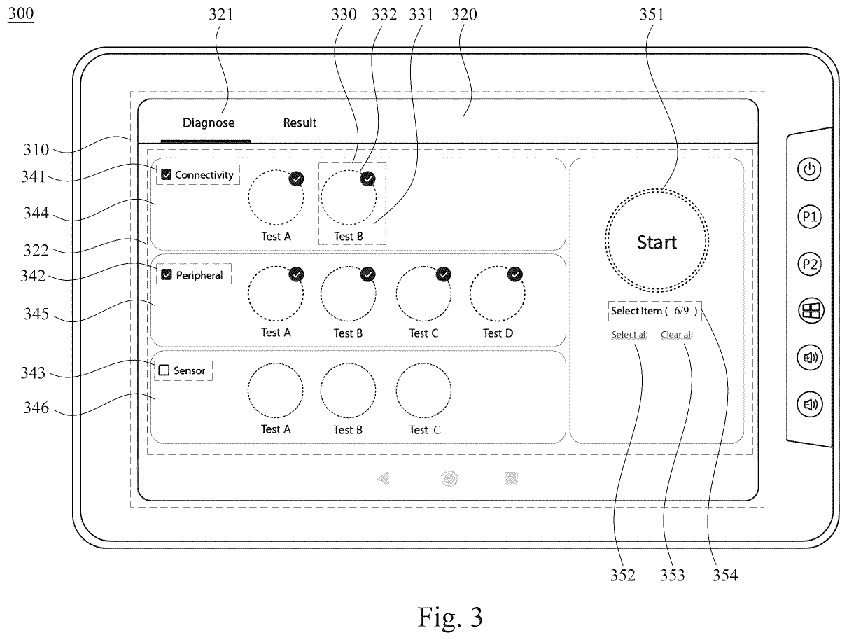

Please refer to FIG. 1, FIG. 2, and FIG. 3. FIG. 2 illustrates a flow chart of a method of testing the electronic device 200 (for the sake of simplicity, the method 200 is referred to as “the method 200” below), in accordance with one embodiment of the present disclosure. In some embodiments, the method 200 can be implemented in the electronic device 100. The method 200 is illustrated with reference to FIG. 2 to FIG. 7.

FIG. 3 illustrates a diagram of a task select screen 322 provided by a display device 310, in accordance with one embodiment of the present disclosure. The display device 310 corresponds to the display device 110 of FIG. 1.

At operation S210, as shown in FIG. 3, a user interface 320 of the display device 310 of an electronic device 300 displays the task select screen 322 including task content buttons 330. When one of the task content buttons 330 corresponding to one of current task contents is activated and regarded as a to-be-tested task and a start button 351 is activated, the user interface 320 is switched from the task select screen 322 to a current task screen.

For example, in some embodiments, a user clicks a task select screen button 321 by touching the user interface 320 or a mouse, and the user interface 320 displays the task select screen 322. The task select screen 322 includes a connectivity area 344, a peripheral area 345, a sensor area 346, a start button 351, a select all button 352, a clear all button 353, and a number of tasks statistical area 354. The connectivity area 344, the peripheral area 345, and the sensor area 346 include select all buttons 341, 342, and 343 respectively, in addition to the task content buttons 330. The task content buttons 330 include task names 331 and the task pictures 332.

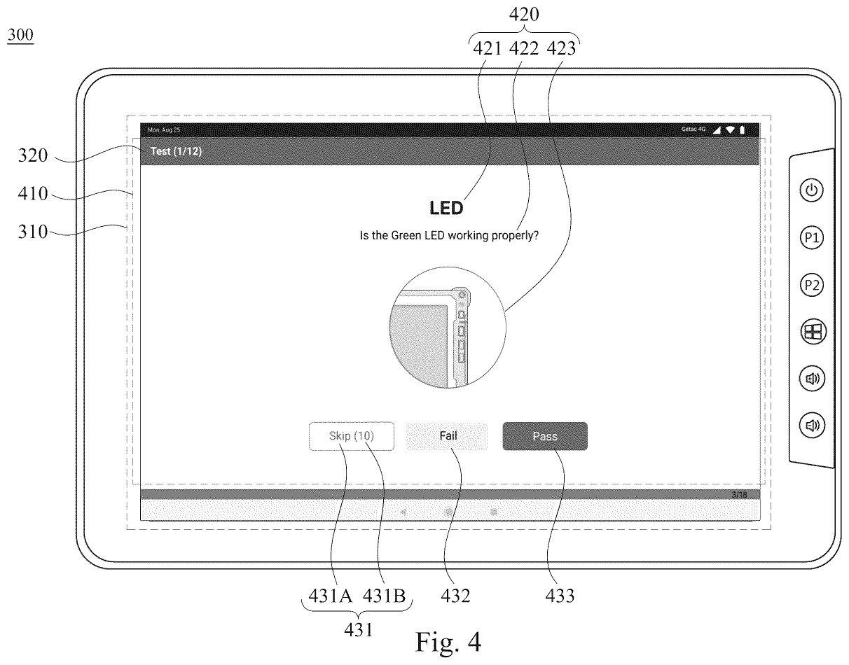

After the user selects tasks on the task select screen 322, selected tasks are included in a to-be-tested list, and a number of to-be-tested tasks is displayed in the number of tasks statistical area 354. Next, by clicking the start button 351, the user interface 320 is switched from the task select screen 322 to a first screen 410 (the current task screen) shown in FIG. 4, and all of the to-be-tested tasks are tested respectively.

For example, in some embodiments, the user clicks one of the task content buttons 330, and at least one of the tasks corresponding to the task content buttons 330 is included in the to-be-tested list. Alternatively, by the select all buttons 341, 342, or 343, all of the task content buttons 330 in the connectivity area 344, the peripheral area 345, or the sensor area 346 are batch selected. Alternatively, by the select all button 352, all of the task content buttons 330 in the task select screen 322 are batch selected.

Taking the embodiment in FIG. 3 for example, when the user clicks Test B (one of the task content buttons 330 in the connectivity area 344), the number of tasks statistical area 354 displays that there is 1 to-be-tested task. Next, the user clicks the start button 351, and the user interface 320 is switched from the task select screen 322 to the first screen 410 shown in FIG. 4, and the electronic device 300 tests the to-be-tested task.

Taking the user clicking the select all button 341 in the connectivity area 344 for example, all of a task Test A and the task Test B in the connectivity area 344 are selected; by clicking the select all button 342 in the peripheral area 345, all of tasks Test A, Test B, Test C, and Test D in the peripheral area 345 are selected. At this moment, the number of tasks statistical area 354 displays that there are 6 to-be-tested tasks. Next, by clicking the start button 351, the user interface 320 is switched from the task select screen 322 to the first screen 410 shown in FIG. 4 and the electronic device 300 tests 6 to-be-tested tasks respectively.

In contrast, after adding the tasks in the to-be-tested list, in accordance with some embodiments, at least corresponding one of the tasks can be removed from the to-be-tested list by clicking at least one of the task content buttons 330 again. All of the to-be-tested tasks in the connectivity area 344, the peripheral area 345, or the sensor area 346 are removed from the to-be-tested list by clicking the select all buttons 341, 342, or 343 again.

In addition, in some embodiments, all of the tasks on the task select screen 322 are removed from the to-be-tested list by clicking the clear all button 353.

For example, by the user clicking the select all button 341 in the connectivity area 344, all of the task Test A and Test B in the connectivity area 344 are selected, but the aforementioned 2 tasks are removed from the to-be-tested list by clicking the select all button 341 again.

In some embodiments, by the user clicking the clear all button 353, all of the tasks in the connectivity area 344, the peripheral area 345, or the sensor area 346 are removed from the to-be-tested list.

For example, the user has clicked the tasks Test A and Test B in the connectivity area 344 and the tasks Test A, Test B, Test C, and Test D in the peripheral area 345, but the 6 tasks mentioned above are removed from the to-be-tested list by clicking the clear all button 353.

In some embodiments, the tasks included in the connectivity area 344 can be a wifi testing, a bluetooth testing, or wired or wireless communication testing. The tasks included in the peripheral area 345 can be a microphone radio function testing, a USB Type-A jack testing, a USB Type-C jack testing, or other hardware testing associated with the electronic device 300. The tasks in the sensor area 346 can be a light sensor testing, a magnetometer testing, a gyroscope testing, an accelerometer testing, or other hardware testing with sensing function.

In some embodiments, the task names 331 can be named based on the task contents, and the task pictures 332 are pictures corresponding to the task contents. For example, if the task content is to test whether a charging cable jack works properly, the task name 331 can be “Testing the charging cable jack”, and the task picture 332 can display a diagram associated with how to test the charging cable jack.

Please refer to FIG. 1, FIG. 2, and FIG. 4. FIG. 4 illustrates a diagram of the first screen 410 provided by the display device 310, in accordance with the embodiment of the present disclosure. With respect to the embodiments of FIG. 1-3, like elements in FIG. 4 are designated with the same reference numbers for ease of understanding. Unless there is a need to illustrate a synergy of the elements, specific operations of similar elements, steps discussed, the specific operations of similar elements, which are already discussed in detail in above paragraphs, are omitted herein for the sake of brevity.

Next, based on operation S221, as shown in FIG. 4, the user interface 320 of the display device 310 displays the first screen 410 (the current task screen) associated with a first task content 420 (the current task content), in which the first screen 410 includes the first task content 420 (the current task content) and a skip button 431.

In some embodiments, the first screen 410 includes a fail button 432 and a pass button 433.

In some embodiments, a text on a text area 431A of the skip button 431 can be “Skip”, and a text on a countdown reading area 431B of the skip button 431 can be “seconds” (e.g., 10). A text on the fail button 432 can be “Fail”, and a text on the pass button 433 can be “Pass”.

In some embodiments, when the user clicks the skip button 431, the fail button 432, or the pass button 433 on the first screen 410, the display device 310 generates corresponding test result statuses—“Skip” (shown as “Skipped” in the user interface 320), “Pending Test” (shown as “Failed” or “Action Required” in the user interface 320) or “Normal” (shown as “Passed” or “Normal” in the user interface 320), and the test result statuses are stored in the memory 130.

For example, if the first task content 420 is to test “whether the green LED works properly”, a first task name 421 can be “LED”, a first task illustration 422 can be “Is the Green LED working properly?”, and a first task picture 423 can be a diagram associated with testing whether the green LED works properly.

When the display device 310 detects that an action result of the skip button 431 is activated, a test result status of the first task content 420 is “Skip”, and the test result status is stored in the memory 130. When the display device 310 detects that an action result of the pass button 433 is activated, a test result status of the first task content 420 is “Normal”, and the test result status is stored in the memory 130. When the display device 310 detects that an action result of the fail button 432 is activated, a test result status of the first task content 420 is “Pending Test”, and the test result status is stored in the memory 130.

Next, at operation S222, it is determined whether a testing of the first task content 420 (the current task content) is completed or not. In some embodiments, the processor 120 determines whether the testing of the first task content 420 is completed or not based on the execution data. If yes, operation S225 is performed. If no, operation S223 is performed.

For example, when the test result status of the first task content 420 is “Normal”, the processor 120 determines that the testing of the first task content 420 has been completed, and the operation S225 is performed. When the test result status of the first task content 420 is “Skip” or “Pending Test”, the processor 120 determines that the testing of the first task content 420 has not been complete, and the operation S223 is performed.

Next, at the operation S223, it is determined whether the action result of the skip button 431 is activated or not. In some embodiments, the display device 310 detects that the action result of the skip button 431 is activated or not. If yes, the operation S225 is performed. If no, operation S224 is performed.

At the operation S224, after the number displayed in the countdown reading area 431B is counted down to zero, the operation S225 is performed.

At the operation S225, the processor 120 determines whether the first task content 420 tested is a last task in the to-be-tested list. If yes, operation S230 is performed. If no, operation S226 is performed.

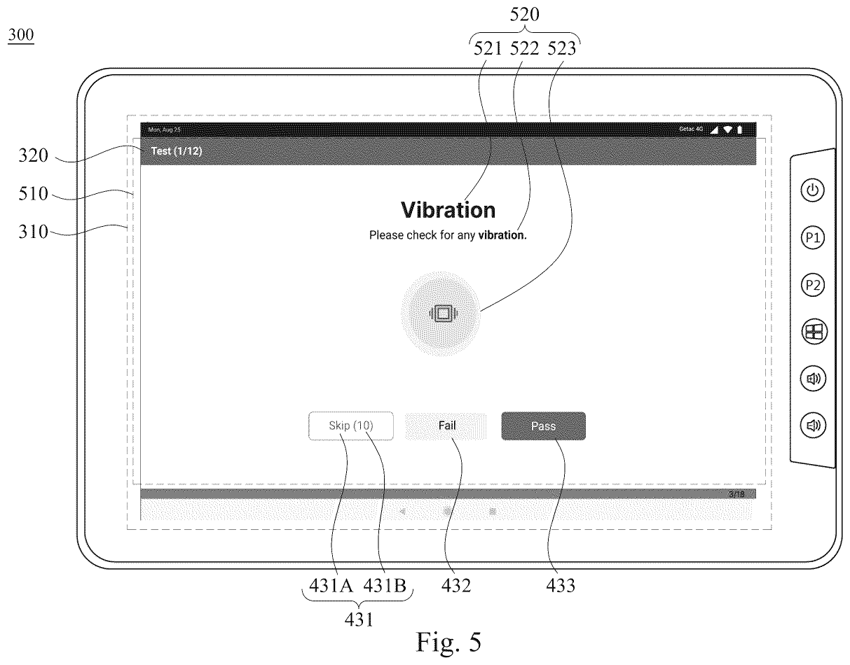

Please refer to FIG. 1, FIG. 2, and FIG. 5. FIG. 5 illustrates a diagram of a second screen 510 provided by the display device 310, in accordance with the embodiment of the present disclosure. With respect to the embodiments of FIG. 1-4, like elements in FIG. 5 are designated with the same reference numbers for ease of understanding.

Based on the operation S226, the user interface 320 of the display device 310 displays a second screen 510 (a next task screen) associated with a second task content 520 (a next task content), in which the second screen 510 includes the second task content 520 (the next task content) and the skip button 431. The second task content 520 includes a second task name 521, a second task illustration 522, and a second task picture 523. The second task content 520 at the operation S226 will enter into the operation S221 to perform the operation S221 to S225 mentioned previously. Thus, a second task is the current task when the second task content 520 enters into the operation S221.

In some embodiments, the task content can be “Vibration testing”, so the second task name 521 can be “Vibration”, the second task illustration 522 can be “Please check for any vibration.”, and the second task picture 523 can be a diagram associated with test whether a vibration function being normal. If the vibration function of the electronic device 300 is normal, the test result status is “Normal”, or the test result status is “Pending Test”.

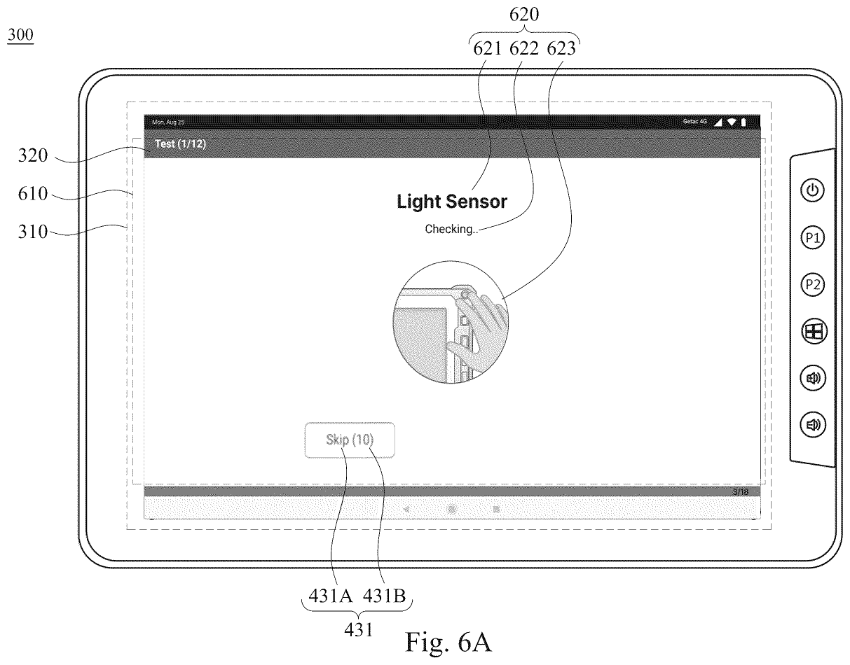

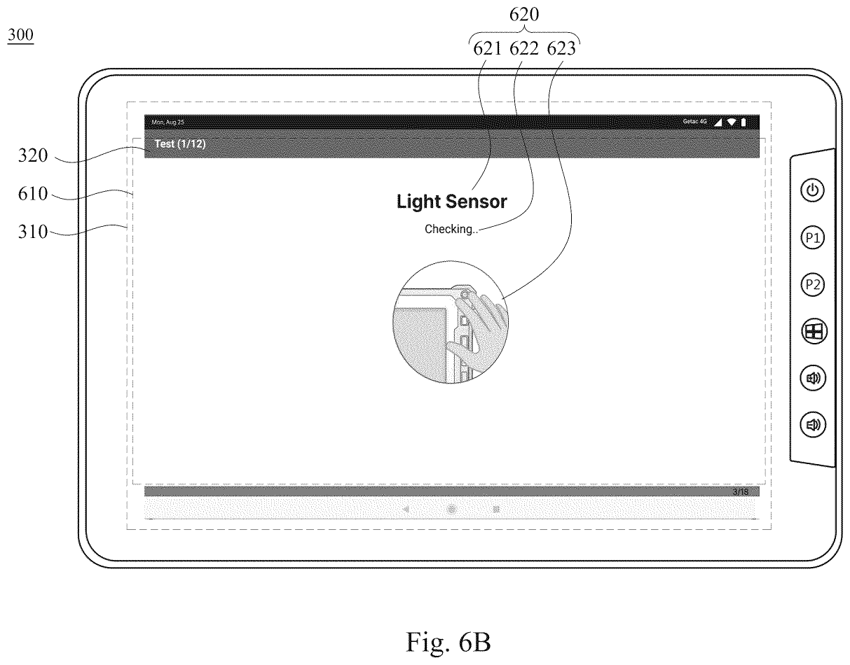

Please refer to FIG. 6A. FIG. 6A illustrates a diagram of a third screen 610 provided by the display device 310, in accordance with the embodiment of the present disclosure. In some embodiments, the first screen 410 or the second screen 510 can be replaced by the third screen 610. In some embodiments, a third task content 620 displayed by the third screen 610 is a testing determined whether being completed the current test by the processor 120 when the user operates part of elements or functions of the display device 310. The user doesn't need to click the fail button 432 or the pass button 433, and the test result status is stored in the memory 130 to make the processor 120 determine whether a testing of the third task content 620 is completed or not. Thus, in some embodiments, the button included the third screen 610 is only the skip button 431 making the user skips the third screen 610.

For example, if the third task content 620 is to test “whether the light sensor works properly”, a third task name 621 can be “Light Sensor”, a third task illustration 622 can be “Checking . . . ”, and a third task picture 623 can be a diagram associated with testing whether the light sensor works properly.

When the display device 310 detects that the action result of the skip button 431 is activated, a test result status of the third task content 620 is “Skip”, and the test result status is stored in the memory 130. For example, when the display device 310 detects that the light sensor can detect a light-dark change, the test result status of the third task content 620 is “Normal”, and the test result status is stored in the memory 130. When the display device 310 detects that the light sensor cannot detect the light-dark change, the test result status of the third task content 620 is “Pending Test”, and the test result status is stored in the memory 130.

In some embodiments, for example, if the third task content 620 is to test “whether the microphone radio function works properly”, the third task name 621 can be “The microphone radio function”, the third task illustration 622 can be “Recording”, and the third task picture 623 can be a diagram associated with testing whether the microphone radio function works properly.

Continuing with the above example, when the display device 310 detects that the action result of the skip button 431 is activated, the test result status of the third task content 620 is “Skip”, and the test result status is stored in the memory 130. When the display device 310 detects a sound recorded by the microphone, the test result status of the third task content 620 is “Normal”, and the test result status is stored in the memory 130. When the display device 310 detects that the microphone cannot record, the test result status of the third task content 620 is “Pending Test”, and the test result status is stored in the memory 130.

In some embodiments, for example, if the third task content 620 is to test “whether the magnetometer works properly”, the third task name 621 can be “The magnetometer testing”, the third task illustration 622 can be “Testing”, and the third task picture 623 can be a diagram associated with testing whether the magnetometer works properly.

Continuing with the above example, when the display device 310 detects that the action result of the skip button 431 is activated, the test result status of the third task content 620 is “Skip”, and the test result status is stored in the memory 130. When the display device 310 detects that the magnetometer can read magnetic field strength around the electronic device 300, the test result status of the third task content 620 is “Normal”, and the test result status is stored in the memory 130. When the display device 310 detects that the magnetometer cannot read magnetic field strength around the electronic device 300, the test result status of the third task content 620 is “Pending Test”, and the test result status is stored in the memory 130.

Next, it is determined by the operation S222 whether a testing of the third task content 620 (the current task content) is completed or not, and the operation after the operation S223 is performed. For the sake of simplicity, the specific operations of the similar elements, the steps discussed in detail in the above paragraphs have been omitted.

Please refer to FIG. 6B. FIG. 6B illustrates a diagram of a third screen 610 provided by the display device 310, in accordance with the embodiment of the present disclosure. In the other embodiments, the third screen 610 doesn't have any buttons.

Taking the third task content 620 being to test “whether the light sensor works properly” mentioned above for example, when the display device 310 detects that the light sensor can detect the light-dark change, the test result status of the third task content 620 is “Normal”, and the test result status is stored in the memory 130. When the display device 310 detects that the light sensor cannot detect the light-dark change, the test result status of the third task content 620 is “Pending Test”, and the test result status is stored in the memory 130.

Taking the third task content 620 being to test “whether the microphone radio function works properly” mentioned above for example, when the display device 310 detects the sound recorded by the microphone, the test result status of the third task content 620 is “Normal”, and the test result status is stored in the memory 130. When the display device 310 detects that the microphone cannot record, the test result status of the third task content 620 is “Pending Test”, and the test result status is stored in the memory 130.

Next, by the operation S222, determine whether a testing of the third task content 620 (the current task content) is completed or not, and perform the operation after the operation S225. Because the embodiment doesn't have the skip button 431, the operation S223 and S224 can be omitted. For the sake of simplicity, the specific operations of the similar elements, the steps discussed in detail in the above paragraphs have been omitted

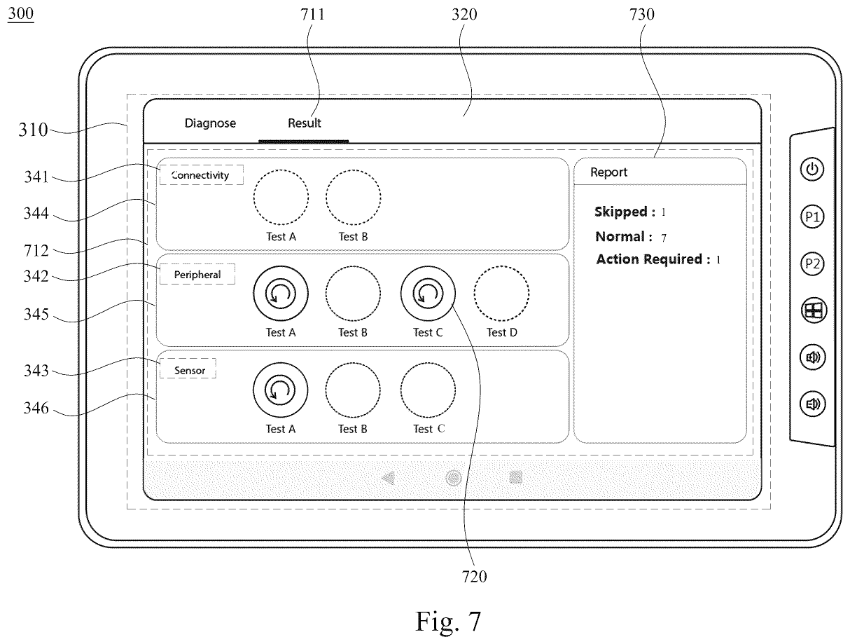

Please refer to FIG. 1, FIG. 2, and FIG. 7. FIG. 7 illustrates a diagram of a test result screen 712 provided by the display device 310, in accordance with the embodiment of the present disclosure.

At the operation S225, if the processor 120 determines that a final task has been completed, the method 200 enters into the operation S230. At the operation S230, the user interface 320 of the display device 310 displays the test result screen 712. The test result screen 712 can include at least one of retest buttons 720. When the test result status of the tested task is “Skip” or “Pending Test”, the retest buttons 720 appears on the corresponding one of the task content buttons 330 on the test result screen 712. The test result screen 712 includes a test result statistical area 730, and the test result statistical area 730 has a statistical result of the execution data. The statistical result is the number of the test result status (“Skip”, “Normal”, or “Pending Test”) of the tested task.

For example, there are total 9 tested tasks. The test result status of Test A and Test C of the peripheral area 345 are “Skip” and “Pending Test” respectively, so there are the retest buttons 720 appears on Test A and Test C of the peripheral area 345, and the result of the test result statistical area 730 is 1 “Skip”, 7 “Normal”, 1 “Pending Test”.

Next, at operation S240, it is determined whether an action result of the retest buttons 720 is activated or not. In some embodiments, the display device 310 detects that the action result of the retest buttons 720 is activated or not. If yes, the operation S226 is performed. If no, the operation S250 is performed, and the method 200 is end.

For example, when the retest button 720 of Test A in the peripheral area 345 is clicked, it enters into the operation S226. A screen of Test A is displayed, and Test A is retested.

In some embodiments, the user can click the task select screen button 321 to enter into the task select screen 322 and reselect the to-be-tested tasks by the operation S210.

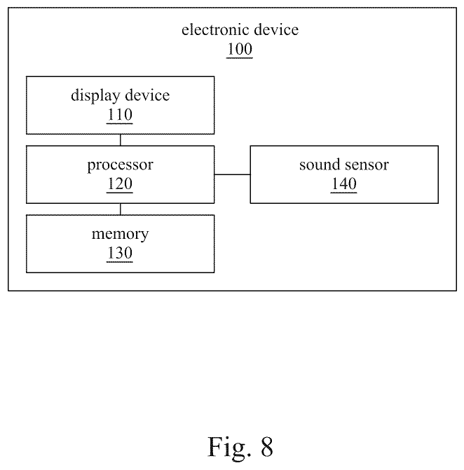

Please refer to FIG. 8. FIG. 8 illustrates a block diagram of the electronic device 100, in accordance with the embodiment of the present disclosure. With respect to the embodiment of FIG. 1, like elements in FIG. 8 are designated with the same reference numbers for ease of understanding. Unless there is a need to illustrate a synergy of the elements, specific operations of similar elements, steps discussed, the specific operations of similar elements, which are already discussed in detail in above paragraphs, are omitted herein for the sake of brevity.

Compared to the embodiment of FIG. 1, the electronic device 100 further includes a sound sensor 140. As shown in FIG. 8, the sound sensor 140 is coupled to the processor 120.

In operational relation, the sound sensor 140 responses to the trigger signal associated with the sound command to switch the user interface 320 to the next task screen different from the current task screen, and the test result statuses of the current task contents is stored in the memory 130.

For example, when the user sends sound signals of “Skip”, “Pass”, or “Fail”, the processor 120 responses to the sound signals to output the control signal to the display device 110 to switch the user interface 320 to the next task screen, and the corresponding test result status “Skip”, “Normal”, or “Pending Test” are stored in the memory 130.

In some embodiments, the task content buttons 330 on the task select screen 322 has an initial value area that can set the number to be counted down. For example, if the user sets the initial value of Test B in the connectivity area 344 to be counted down is 15 seconds, the countdown reading area 431B on the screen counts down from 15 when testing Test B.

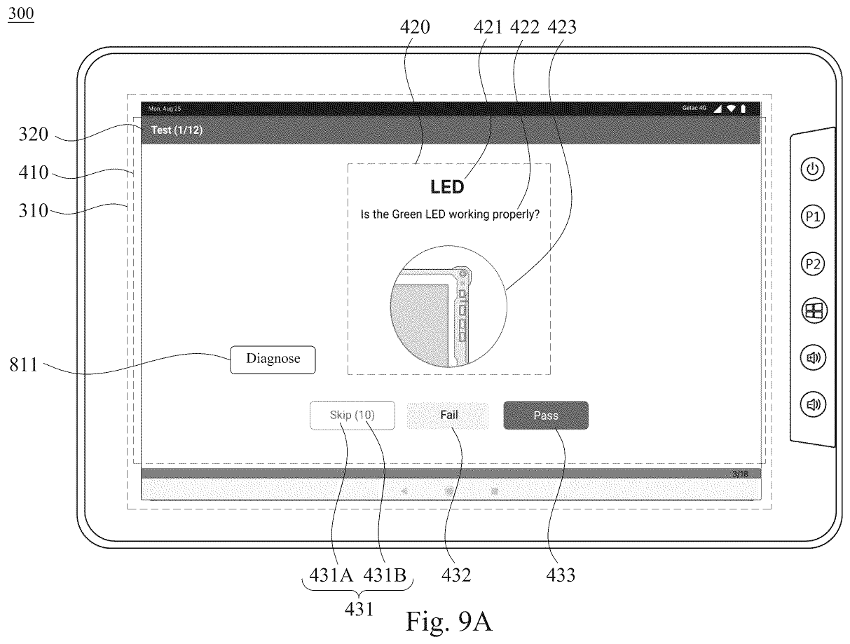

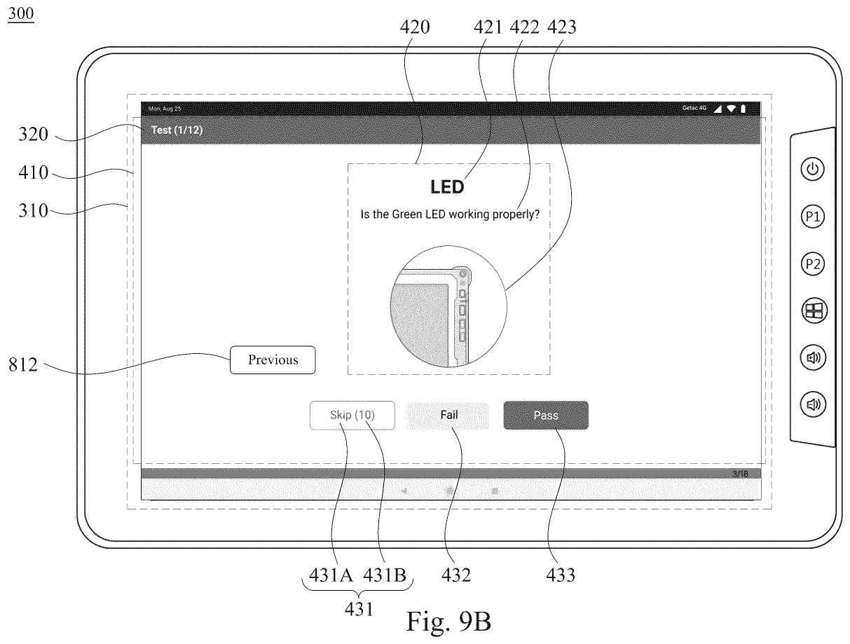

Please refer to FIG. 9A. FIG. 9A illustrates a diagram of an embodiment provided by the display device 310, in accordance with the embodiment of the present disclosure. In some embodiments, the current task screen has a return to the task select screen button (return button) 811. When the user clicks this return button 811, a current testing is stopped and turns back to the task select screen 322 to reselect to-be-tested task contents before restarting to test.

Please refer to FIG. 9B. FIG. 9B illustrates a diagram of an embodiment provided by the display device 310, in accordance with the embodiment of the present disclosure. In some embodiments, the current task screen has a return button 812. When the user clicks this return button 812, the current testing is stopped and turns back to a previous task screen to retest a previous task content before retesting the current task content.

In some embodiments, the return to the task select screen button 811 and the return button 812 can appear together on the current task screen.

In some embodiments, the method 200 further includes the processor 120 setting the initial value of the countdown reading area 431B to be counted down by a deep learning method based on the many execution time data stored in the memory 130.

For example, by the deep learning method, the processor 120 finds that an execution time grows linearly based on the execution time (e.g., 10, 20, and 30 seconds) spent on previous testings (e.g., a total of 3 previous testings) of Test B in the connectivity area 344. The countdown reading area 431B on the screen starts counting down from 40 seconds for the next test that tests Test B.

Although the above implementation method discloses the specific implementation examples of this present disclosure, it is not intended to limit this present disclosure. The people having ordinary skill in the art may make various changes and modifications to them without departing from the principle and spirit of this present disclosure, so the scope of protection in this present disclosure shall be based on the scope of protection defined in the claims.

What is claimed is:

1. A method of testing electronic device, comprising:
displaying, by a user interface of a display device, a first screen, wherein the first screen comprises a first task content and a first interactive button, and the first interactive button has a countdown reading area and a text area;
switching the user interface to a second screen when a number displayed in the countdown reading area is counted down to zero, wherein the second screen is different from the first screen; and
switching the user interface to the second screen and storing, by a memory, execution data corresponding to the first task content when the display device detects a first action result of the first interactive button and the first action result is that the first interactive button is activated.

2. The method of claim 1, further comprising:
switching the user interface to the second screen in response to a trigger signal associated with a sound command.

3. The method of claim 1, further comprising:
displaying, by the user interface, a task select screen, wherein the task select screen comprises a plurality of task content buttons; and
switching the user interface from the task select screen to the first screen when one of the plurality of task content buttons corresponding to the first task content is activated.

4. The method of claim 3, further comprising:
when a select all button of the user interface is activated and all of the plurality of task content buttons are referred to as being activated, switching the user interface from the task select screen to the first screen.

5. The method of claim 3, further comprising:
when a clear all button of the user interface is activated and all of the plurality of task content buttons are referred to as being non-activated, maintaining the user interface on the task select screen.

6. The method of claim 1, further comprising:
displaying, by the user interface, a task select screen, wherein the task select screen comprises a plurality of task content areas composed of a plurality of time setting areas and a plurality of task content buttons;
setting, by one of the plurality of time setting areas corresponding to the first task content, the number displayed in the countdown reading area; and
switching the user interface from the task select screen to the first screen when one of the plurality of task content buttons corresponding to the first task content is activated.

7. The method of claim 6, further comprising:
switching the first screen to the task select screen when a return button of the first screen is activated.

8. The method of claim 1, further comprising:
switching the second screen to the first screen when a return button of the second screen is activated.

9. The method of claim 1, further comprising:
displaying, by the user interface, a test result screen, wherein the test result screen comprises the execution data.

10. The method of claim 1, wherein the execution data is one of a plurality of test result statuses, and the plurality of test result statuses comprise a skip, a normal, and a pending test.

11. The method of claim 1, wherein the first task content is a first task picture indicating a test method corresponding to the first task content.

12. The method of claim 1, wherein the first task content is a first task illustration indicating a test method corresponding to the first task content.

13. The method of claim 1, further comprising:
after storing, by the memory, the execution data corresponding to the first task content, when the display device detects a second action result of a second interactive button and the second action result is that the second interactive button is activated, switching the user interface to the first screen.

14. The method of claim 1, further comprising:
storing, by the memory, a plurality of execution time data corresponding to the first task content.

15. The method of claim 14, further comprising:
generating, by a processor, an initial value of the number displayed in the countdown reading area based on the plurality of execution time data.

16. An electronic device, comprising:
a display device configured to provide a user interface that displays a first screen, wherein the first screen comprises a first task content and an interactive button, and the interactive button has a countdown reading area and a text area;
a processor configured to countdown a number associated with the first task content and output a control signal to the display device for displaying the number in the countdown reading area,
wherein when the number is counted down to zero, the user interface is switched to a second screen, and the second screen is different from the first screen, and
when the display device detects an action result of the interactive button and the action result is that the interactive button is activated, the processor is further configured to output the control signal to the display device based on the action result for switching the user interface to the second screen; and
a memory configured to store execution data corresponding to the first task content.

17. The electronic device of claim 16, further comprising:
a sound sensor configured to detect a sound to generate a sound signal;
wherein the processor is further configured to output the control signal to the display device in response to the sound signal to switch the user interface to the second screen.

18. The electronic device of claim 16, wherein the user interface is further configured to display a task select screen comprising a plurality of task content buttons,
wherein the display device outputs a trigger signal to the processor when one of the plurality of task content buttons corresponding to the first task content is activated,
wherein the processor is further configured to output the control signal to the display device in response to the trigger signal to switch the user interface from the task select screen to the first screen.

19. The electronic device of claim 16, wherein the user interface is further configured to display a task select screen, wherein the task select screen comprises a plurality of task content areas composed of a plurality of time setting areas and a plurality of task content buttons,
wherein when the processor receives a time setting signal corresponding to the first task content in the plurality of time setting areas, the processor outputs the control signal to the display device to display the number responsive to the time setting signal in the countdown reading area,
wherein the display device outputs a trigger signal to the processor when one of the plurality of task content buttons corresponding to the first task content is activated,
wherein the processor is further configured to output the control signal to the display device in response to the trigger signal to switch the user interface from the task select screen to the first screen.

20. The electronic device of claim 16, wherein the memory is further configured to store a plurality of execution time data corresponding to the first task content,
wherein the processor generates an initial value of the number displayed in the countdown reading area based on the plurality of execution time data.
